(19) United States
(12) Patent Application Publication
(10) Pub. No.: US 2017/0098994 A1
(43) Pub. Date: Apr. 6, 2017

(54) CURRENT REGULATOR WITH REGULATED SUPPLY VOLTAGE

(71) Applicant: Atmel Corporation, San Jose, CA (US)

(72) Inventors: Ingo RUHM, Dresden (DE); Juergen GROSSEHELWEG, Radeberg (DE)

(73) Assignee: Atmel Corporation, San Jose, CA (US)

(21) Appl. No.: 14/875,255

(22) Filed: Oct. 5, 2015

(51) Int. Cl. H02M 3/04; H05B 33/08

(52) U.S. Cl. CPC H02M 3/04; H05B 33/0845

(57) ABSTRACT

In an embodiment, a circuit comprises: a current regulator configured to selectively couple a first voltage supply to an energy storage device coupled to a load to regulate current through the load; and a voltage regulator configured to selectively couple a charge storage device to the load and to regulate a second voltage supply provided by the charge storage device.

### TECHNICAL FIELD

The subject matter of this disclosure relates generally to current regulators.

### BACKGROUND

Light emitting diode (LED) lighting systems are used in a variety of applications, including but not limited to instrument lighting, automotive headlamps, advertising, video displays and the like. In such applications, LED lighting systems can provide several advantages over incandescent lighting systems such as lower energy consumption, longer lifetime, smaller size and faster switching.

### SUMMARY

In an embodiment, a circuit comprises: a current regulator configured to selectively couple a first voltage supply to an energy storage device coupled to a load to regulate current through the load; and a voltage regulator configured to selectively couple a charge storage device to the load and to regulate a second voltage supply provided by the charge storage device.

In an embodiment, a method comprises: regulating, by a current regulator, current through a load, the load coupled to an energy storage device that is selectively coupled by the current regulator to a first voltage supply; charging a charge storage device with load current; and regulating, by a voltage regulator, a second voltage supply provided by the charge storage device, the charge storage device selectively coupled by the voltage regulator to the load.

In an embodiment, a lighting system comprises: a light emitting diode (LED); a storage capacitor; an inductor coupled in series with the LED; a current regulator configured to selectively couple a first voltage supply to the inductor to regulate current through the LED; and a voltage regulator configured to selectively couple the storage capacitor to the LED and to regulate a second voltage supply provided by the storage capacitor.

### BRIEF DESCRIPTION OF THE DRAWINGS

FIG. 1 is a block diagram of an example current regulator with a regulated second voltage supply generated from load current, according to an embodiment.

FIG. 2 is a schematic diagram of an example current regulator for an LED lighting application, according to an embodiment.

FIGS. 3A and 3B are timing diagrams for switches SW1, SW2 of the current switching regulator of FIG. 2, according to an embodiment.

FIG. 4 is a flow diagram of an example process for voltage regulation using the circuit of FIG. 2, according to an embodiment.

FIG. 5 is a flow diagram of an example process for current regulation using the circuit of FIG. 2, according to an embodiment.

### DETAILED DESCRIPTION

### Example Circuit

In accordance with an example scenario, a light emitting diode (LED) system includes a current regulator that uses a first voltage supply (e.g., 40V) to drive a current through an LED string and a second voltage supply (e.g., 3.3V to 5V) to control the LED system. The second voltage supply may be provided by a second voltage regulator or by a circuit extension of the first voltage supply. However, there may be financial costs associated with implementing these circuit arrangements in the power supply for the LED system.

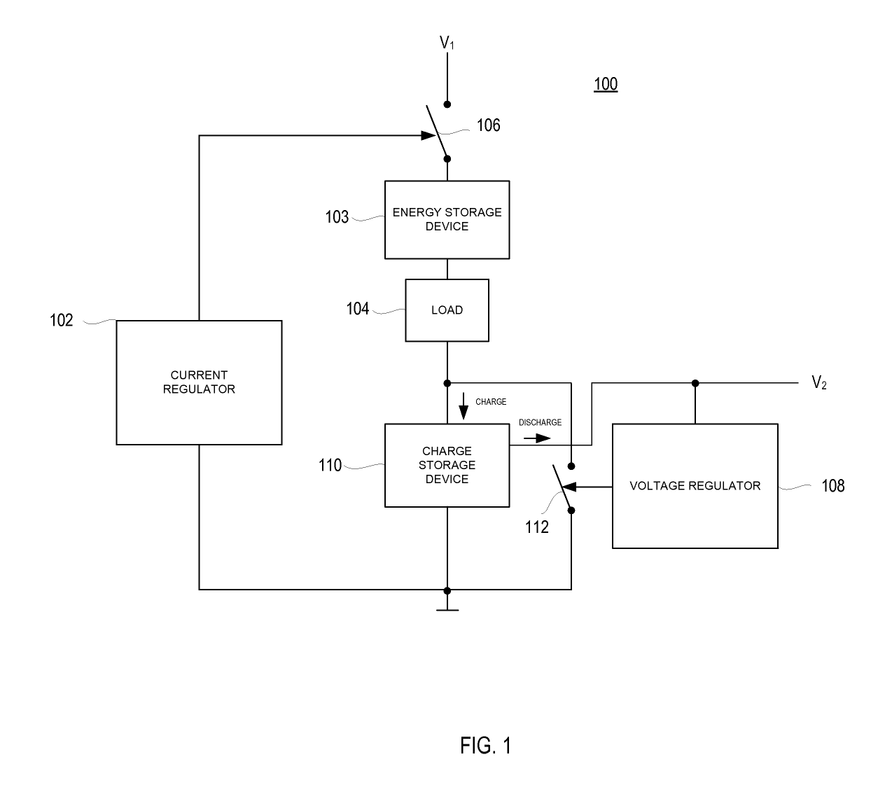

FIG. 1 is a block diagram of an example circuit 100 that regulates current through a load and also regulates a second voltage supply generated by load current, according to an embodiment. Circuit 100 can include current regulator 102, energy storage device 103 (e.g., an inductor), voltage regulator 108, charge storage device 110 (e.g., a capacitor), load 104 and switches 106 and 112. Voltage regulator 108 selectively couples load 104 to charge storage device 110 using switch 112. Voltage regulator 108 is configured to regulate a second voltage supply (V₂) over charge storage device 110 by comparing the second voltage supply V₂ to a first target voltage.

In an embodiment, charge storage device 110 is coupled to load 104 and begins to charge from load current when the second voltage supply V₂ is lower than the first target voltage. Charge storage device 110 is decoupled from load 104 when the second voltage supply V₂ is higher than the first target voltage. Although charge storage device 110 can be designed to impede discharge when decoupled from the load current, charge storage device 110 will nonetheless slowly discharge until the second voltage supply V₂ is lower than the first target voltage, at which time switch 112 will again couple charge storage device 110 to load 104 to start charging from the load current. Accordingly, the regulated second voltage supply V₂ is generated by charge storage device 110. The charge storage device 110 is charged using load current provided by the first voltage supply V₁.

Current regulator 102 selectively couples load 104 to the first voltage supply V₁ using switch 106. Current regulator 102 is configured to regulate current through load 104 to a second target voltage. Energy storage device 103 (e.g., an inductor) provides current to load 104 when the first voltage supply V₁ is decoupled from load 104.

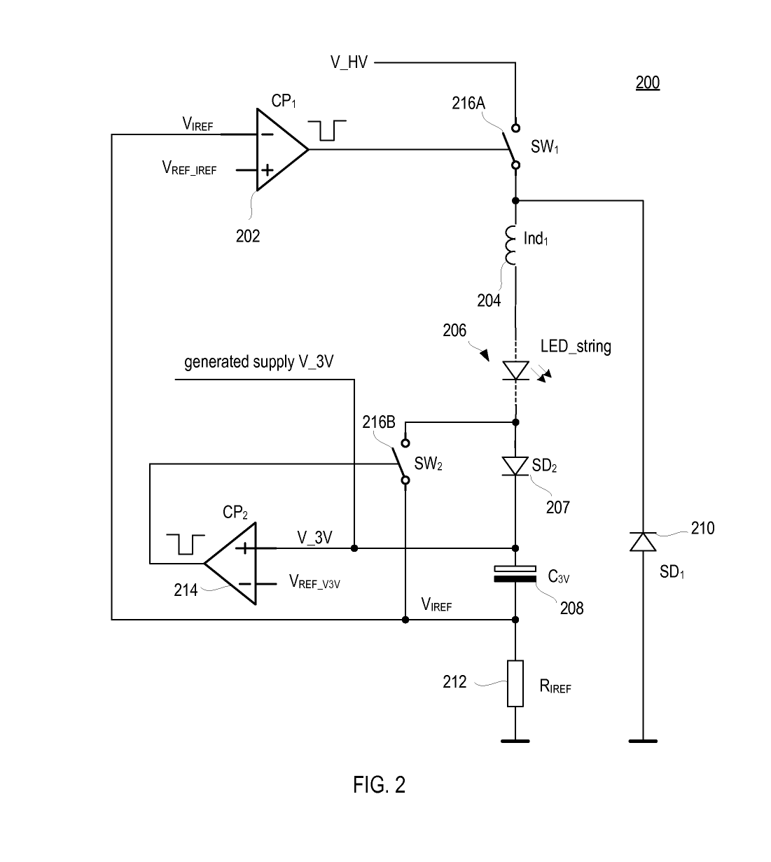

FIG. 2 is a schematic diagram of an example current regulator 200 for an LED lighting application, according to an embodiment. In some embodiments, current regulator 200 can include comparator 202 (CP1), inductor 204, LED string 206, diode 207 (SD2), storage capacitor 208, diode 210 (SD1), resistor 212, comparator 214 (CP2), switch 216A (SW1) and switch 216B (SW2).

Comparator 202 compares a voltage generated by LED string current (V_IREF) with a reference voltage (V_REF_IREF), and generates an output that controls or toggles (e.g., opens or closes) switch 216A to thereby couple or decouple high voltage supply (V_HV) from LED string 206. Inductor 204 is coupled in series with LED string 206 and can include one or more coils. LED string 206 can include one or more LEDs or other light emitting elements. Diode 207 is coupled in series with LED string 206 and storage capacitor 208, and can be, for example, a Schottky diode. Diode 207 is configured to decouple a low voltage supply (V_3V) across storage capacitor 208 from switch 216B, to prevent a discharge of storage capacitor 208 when switch 216B is closed. Storage capacitor 208 is configured to store charge when switch 216A is opened and to generate V_3V. Diode 210 is coupled to inductor 204 and configured to supply inductor 204 with current when V_HV is decoupled by switch 216A. In some embodiments, diode 210 is a free-wheeling diode configured to eliminate “fly back” (e.g., a sudden voltage spike) across inductor 204 when V_HV is decoupled by switch 216A.

Resistor 212 (R_IREF) is coupled in series with storage capacitor 208 and switch 216B and is used to transform the LED string current into a voltage (V_IREF). In some implementations, resistor 212 can be a resistive network or a variable resistor. Comparator 202 compares V_IREF with a reference voltage VREF_IREF and generates an output that controls switch 216A. Switch 216A is coupled to the output of comparator 202 and couples or decouples V_HV to LED string 206. Switch 216B controls the charge and discharge of storage capacitor 208.

Although the example circuit 200 is configured for an LED lighting application, circuit 100, and variations thereof, can also be used to achieve current regulation for other applications, such as those that could benefit from a low cost secondary voltage supply.

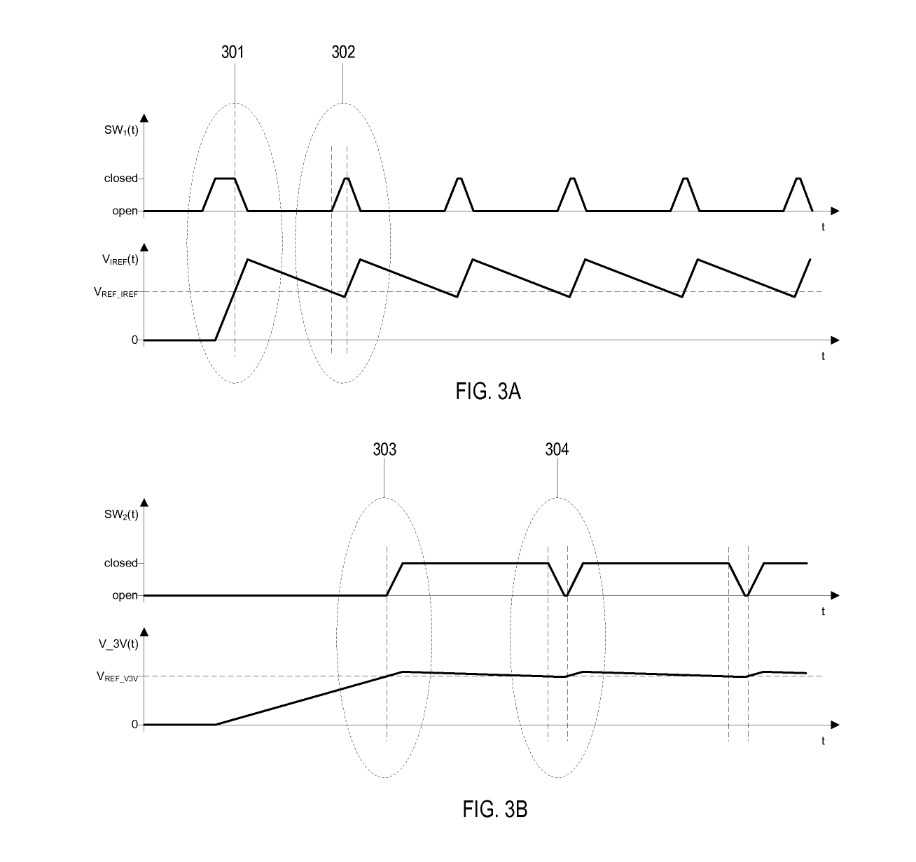

FIGS. 3A and 3B are timing diagrams for switches SW1, SW2 of the current switching regulator of FIG. 2, according to an embodiment. The operation of circuit 200 will now be described in reference to circuit 200 and the timing diagrams shown in FIGS. 3A and 3B.

In an embodiment, a startup circuit or a dedicated startup voltage capacitor is coupled to circuit 200 to provide a startup voltage during a startup phase. When the startup voltage is sufficient to operate comparators 202, 214, and to drive switches 216A and 216B, switch 216A changes to CLOSE state. Switch 216B starts in OPEN state. This configuration of switches 216A, 216B causes a current to flow through inductor 204 and LED string 206. Because switch 216B is in OPEN state, storage capacitor 208 is charged by LED string current. Comparator 214 compares voltage V_3V with voltage reference V_REF_3V3, and if V_3V is higher than V_REF_V3V, switch 216B is changed to CLOSE state and the LED string current flows directly via switch 216B to resistor 212. Diode 207 prevents discharging of storage capacitor 208 through switch 216B when switch 216B is in CLOSE state.

In an embodiment, current regulation through LED string 206 is controlled by resistor 212, comparator 202, switch 216A, diode 210 and inductor 204 to maintain steady current flow through LED string 206. Resistor 212 transforms the LED string current into voltage V_IREF. V_IREF is compared with comparator 202 against voltage reference V_REF_IREF. If the current through LED string 206 is below V_REF_IREF, switch 216A changes to CLOSE state. If the current is above V_REF_IREF, switch 216A changes to OPEN state. When switch 216A is in OPEN state, V_HV is decoupled and diode 210 supplies inductor 204 with current. Inductor 204 drives the decreasing current through LED string 206 until the current is below V_REF_IREF, at which time switch 216A will change to CLOSE state again, coupling V_VH to inductor 204 and LED string 206.

In circuit 200, comparator 202 is regulating the current flow through LED string 206 to a target current and comparator 214 is regulating the voltage over storage capacitor 208 to a target voltage. Circuit 200 therefore is advantageous in that a single voltage supply V_HV can be used to drive current through a load (e.g., LED string 206) and to generate a secondary voltage supply that can be used to power at least a portion of circuit 200, thus reducing the overall cost of the power supply.

Referring to FIG. 3A, V_IREF exceeds V_REF_IREF causing switch SW1 to change from CLOSE state to OPEN state (event 301). When V_HV is decoupled by SW1, the current through inductor 204 and LED string 206 begins to decrease, causing V_IREF to decrease. V_IREF drops below V_REF_IREF, causing SW1 to change to a CLOSE state (event 302). With V_HV coupled again to inductor 204 and LED string 206, V_IREF begins to increase and the cycle repeats.

Referring to FIG. 3B, the voltage across storage capacitor 208 (V_3V) exceeds V_REF_V3V, resulting in switch SW2 changing from OPEN state to CLOSE state (event 303). With SW2 in CLOSE state, storage capacitor 208 starts to discharge until V_3V drops below V_REF_V3V, at which time SW2 changes from CLOSE state to OPEN state (event 304).

### Example Process

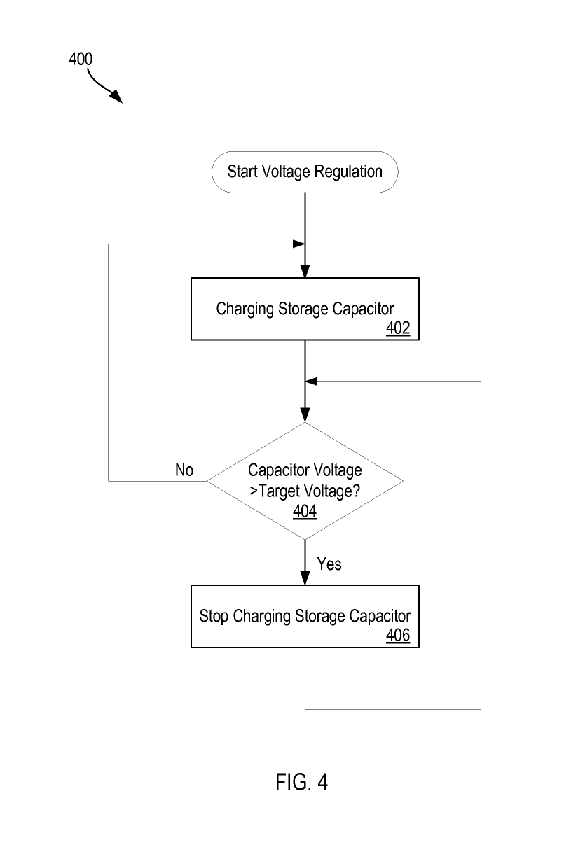

FIG. 4 is a flow diagram of an example process 400 for voltage regulation using the circuit of FIG. 2, according to an embodiment. Process 400 can be implemented by, for example, circuit 200 shown in FIG. 2.

In an embodiment, process 400 can begin by charging a storage capacitor (402) of a circuit, such as a current regulator for a LED lighting application. If (404), the voltage across the storage capacitor is greater than a target voltage, the charging is stopped (406). Otherwise, the charging continues. For example, a switch controlled by a comparator output can shunt the storage capacitor when the voltage across the storage capacitor exceeds a target voltage as determined by the comparator output. While shunted, the capacitor will start to discharge over time and when the voltage across the capacitor drops below the target voltage, the switch is opened to allow current from the voltage supply to start charging the storage capacitor again. This regulated voltage across the storage capacitor can be used as a second voltage supply (e.g., a low voltage supply) to power components of the circuit, such as the comparator. In an embodiment, a diode coupled to the storage capacitor is used to prevent the storage capacitor from discharging through the switch, as described in reference to FIG. 2.

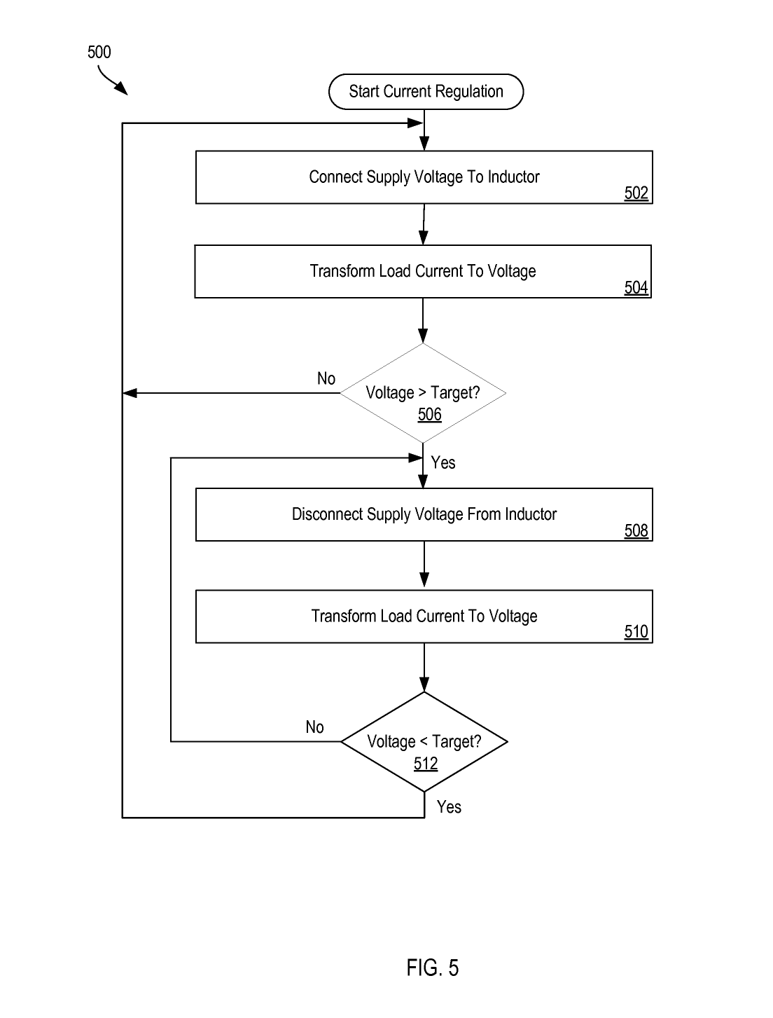

FIG. 5 is a flow diagram of an example process 500 for current regulation using the circuit of FIG. 2, according to an embodiment.

In an embodiment, process 500 can begin by coupling a voltage supply to an inductor (502). For example, in an LED lighting application a high voltage supply can be used to supply LED string current through the inductor.

Process 500 can continue by transforming the load current into a voltage (504). For example, a resistor can be coupled in series with the load to transform the current into a voltage that changes with changes in the load current.

Process 500 can continue by determining if (506) the voltage exceeds a target voltage, and then decoupling the voltage supply from the inductor (508). For example, when the voltage exceeds the target voltage, a switch can be controlled by a comparator output to decouple the voltage supply, thus enabling the inductor to drive current to the load. In an embodiment, a free-wheeling diode can be coupled in series with the inductor to eliminate voltage spikes due to decoupling of the voltage supply, as described in reference to FIG. 2.

Process 500 can continue by transforming the load current to a voltage (510), and if (512) the voltage drops below the target voltage, coupling the voltage supply to the inductor (502). Referring to FIGS. 4 and 5, the current flowing through the inductor is coupled to the storage capacitor when the generated secondary voltage supply is below the target, and the inductor current is bypassing the storage capacitor through switch SW2 when the generated secondary voltage supply is above the target voltage.

As shown in FIG. 2, the regulation of voltage across the storage capacitor performed by process 400 and the regulation of load current by process 500 can be implemented together in an integrated circuit, such as circuit 200, by controlling switches using comparator outputs. The circuit 200 and related processes 400, 500, provide a low cost power supply solution for current regulators by using a charge storage device and diode coupled in series with the load to generate a second voltage supply for powering the circuit components.

While this document contains many specific implementation details, these should not be construed as limitations on the scope of what may be claimed but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A circuit comprising:
a current regulator configured to selectively couple a first voltage supply to an energy storage device coupled to a load to regulate current through the load; and
a voltage regulator configured to selectively couple a charge storage device to the load and to regulate a second voltage supply provided by the charge storage device, wherein a first terminal of the charge storage device is coupled to a first input terminal of the voltage regulator and a second terminal of the charge storage device is coupled to a resistor, and wherein a voltage across the resistor regulates the current through the load.

2. The circuit of claim 1, wherein the charge storage device is coupled to the load when the second voltage supply is lower than a first target voltage, and the charge storage device is decoupled from the load when the second voltage supply is higher than the first target voltage.

3. The circuit of claim 1, wherein the voltage regulator comprises:
a first comparator coupled to the charge storage device and a first target voltage; and
a first switch controlled by the first comparator to shunt the charge storage device based on comparison of the second voltage supply and the first target voltage.

4. The circuit of claim 3, further comprising:
a first diode coupled in series with the charge storage device and coupled in parallel with the first switch.

5. The circuit of claim 4, further comprising:
a second comparator coupled to the resistor and a second target voltage; and
a second switch controlled by the second comparator to selectively couple or decouple the first voltage supply to the energy storage device based on comparison of a voltage across the resistor and the second target voltage.

6. The circuit of claim 5, further comprising:
a second diode coupled to the energy storage device, wherein the energy storage device is configured to store energy when the second switch is in a first state and configured to deliver current to the load when the second switch is in a second state.

7. The circuit of claim 1, wherein the load includes one or more light emitting diodes.

8. The circuit of claim 1, wherein the first voltage supply is higher than the second voltage supply and the second voltage supply is used to power at least a portion of the circuit.

9. The circuit of claim 1, further comprising:
a startup circuit coupled to the circuit and configured to provide a startup voltage to the circuit during a start up period.

10. A method comprising:
regulating, by a current regulator, current through a load, the load coupled to an energy storage device that is selectively coupled by the current regulator to a first voltage supply;
charging a charge storage device with load current, wherein a first terminal of the charge storage device is coupled to a first input terminal of a voltage regulator and a second terminal of the charge storage device is coupled to a resistor, and wherein a voltage across the resistor regulates the current through the load; and
regulating, by the voltage regulator, a second voltage supply provided by the charge storage device, the charge storage device selectively coupled by the voltage regulator to the load.

11. The method of claim 10, further comprising:
coupling the charge storage device to the load when the second voltage supply is lower than a first target voltage; and
decoupling the charge storage device from the load when the second voltage supply is higher than the first target voltage.

12. The method of claim 10, further comprising:
shunting the charge storage device based on comparison of the second voltage supply across the charge storage device and a first target voltage.

13. The method of claim 10, further comprising:
selectively coupling or decoupling a first voltage supply to the energy storage device based on comparison of a voltage across the resistor and a second target voltage.

14. The method of claim 10, further comprising:
storing energy in the energy storage device in a first state and delivering current generated by the energy storage device to the load in a second state.

15. The method of claim 10, wherein the load includes one or more light emitting diodes.

16. The method of claim 15, further comprising:
powering at least a portion of the current regulator or voltage regulator with the second voltage supply.

17. A lighting system comprising:
a light emitting diode (LED);
a storage capacitor;
a resistor coupled to a first terminal of the storage capacitor;
an inductor coupled in series with the LED;
a current regulator configured to selectively couple a first voltage supply to the inductor to regulate current through the LED; and
a voltage regulator coupled to a second terminal of the storage capacitor, the voltage regulator configured to selectively couple the storage capacitor to the LED and to regulate a second voltage supply provided by the storage capacitor, and wherein a voltage across the resistor regulates the current through the LED.

18. The system of claim 17, wherein the storage capacitor is coupled to the LED when the second voltage supply is lower than a first target voltage, and the storage capacitor is decoupled from the LED when the second voltage supply is higher than the first target voltage.

19. The system of claim 17, wherein the voltage regulator comprises:
a first comparator coupled to the storage capacitor and the first target voltage; and
a first switch controlled by the first comparator to shunt the storage capacitor based on comparison of the second voltage supply and the first target voltage.

20. The system of claim 19, further comprising:
a second comparator coupled to the resistor and a second target voltage; and
a second switch controlled by the second comparator to selectively couple or decouple the first voltage supply to the inductor based on comparison of a voltage across the resistor and the second target voltage.
